(19) United States
(12) Patent Application Publication
(10) Pub. No.: US 2012/0327647 A1
(43) Pub. Date: Dec. 27, 2012

(54) Configurable Modular LED Lighting Kit

(76) Inventor: Rick Husong, Los Angeles, CA (US)

(21) Appl. No.: 13/531,332

(22) Filed: Jun. 22, 2012

Related U.S. Application Data
(60) Provisional application No. 61/500,035, filed on Jun. 22, 2011.

(51) Int. Cl. F21S 4/00

(52) U.S. Cl. 362/220

(57) ABSTRACT

A configurable modular LED lighting kit may comprise a spine element and one or more branch elements. The spine element may be plastically bendable and elongated with a multiplicity of lateral faces, and include a first end, a second end, and a plurality of connection stations disposed therebetween. Each connection station may have a multiplicity of connection points. The connection points may be defined by a combination of a spine positive electrical contact, a spine negative electrical contact and a connection point LED. Each branch element may be flexible and include a plurality of branch LEDs and a spine connector. Each of the spine connectors may have a branch positive electrical contact, a branch negative electrical contact, and be configured to electrically releasably connect with any of the connection points. The kit may include a 24-volt DC LED power supply electrically connectable between a wall outlet and the spine element.

### RELATED APPLICATIONS

This application claims the benefit of U.S. Provisional Application No. 61/500,035 filed Jun. 22, 2011, the content of which is incorporated by this reference in its entirety for all purposes as if fully set forth herein.

### TECHNICAL FIELD

The present invention relates generally to the field of stringed lighting systems. More particularly, the invention relates to low-voltage LED lighting kits which include flexible, interconnectable and extendable power bus and light string elements.

### BACKGROUND

Christmas tree lighting has been generally unchanged for the past forty years. Some of the most notable improvements have been the introduction of color, twinkle lights and recently, the introduction of LED lights. Conventional tree lighting methods still typically involve starting at the bottom of the tree and wrapping yards and yards of wire and indecent bulbs around the tree. A well-lit tree tends to have balance and symmetry. To accomplish this with conventional Christmas tree lights typically requires considerable time and care. Using common conventional lighting means, a seven foot tree can take more than an hour of time and over 1000 bulbs to light well, not to mention the pain staking process of removing the lights after the holidays.

Consumers around the globe spend millions of dollars on countless Christmas gimmicks, and the Christmas tree remains the centerpiece of one of the biggest holidays in the world. Those in the art, and consumers alike, recognize the need for a safer and more convenient way to light the Christmas tree while producing a more balanced and symmetrical result.

### SUMMARY

A configurable modular LED lighting kit may comprise a spine element and one or more branch elements. The spine element may be plastically bendable and elongated with a multiplicity of lateral faces, and include a first end, a second end, and a plurality of connection stations disposed therebetween at distinctive distances from the first end. Each of the connection stations may have a multiplicity of connection points thereat. The connection points may be defined by a combination of a spine positive electrical contact, a spine negative electrical contact and a connection point LED. The connection points of a connection station may each corresponding to a respective one of the lateral faces. The spine element may further include a polymeric body which is substantially light permeable. The spine positive electrical contacts and spine negative electrical contacts may be generally embedded in or affixed to the polymeric body.

Each of the branch elements may be flexible and include a proximal end, a distal end and a plurality of branch LEDs disposed therebetween. Each of the proximal ends may have a spine connector generally thereat. Each of the spine connectors may have a branch positive electrical contact, a branch negative electrical contact, and be configured to receivingly and electrically releasably connect with any of the connection points. The kit may include a 24-volt DC LED power supply electrically connectable between a wall outlet and the spine element.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic side view of a spine element in accordance with one embodiment;

FIG. 2 is a diagrammatic magnified side view a spine element in accordance with one embodiment, illustrating a version of a plurality of connection stations with respective electrical contacts and magnetic poles;

FIG. 3 is a diagrammatic partial cross-sectional view taken along line 3-3 of FIG. 1, illustrating a plurality of connection points at a connection station on a spine element having a multiplicity of lateral and corner faces;

FIG. 4 is a diagrammatic side view of a branch element in accordance with one embodiment;

FIG. 5 is a diagrammatic front view of a spine connector in accordance with one embodiment, illustrating respective branch electrical contacts and magnetic poles;

FIG. 6 is a diagrammatic top view of the spine connector of FIG. 5; and

FIG. 7 is a diagrammatic section view taken along line 3-3 of FIG. 1, illustrating two spine connectors and a connection station of one embodiment, one spine connector being shown connected to a connection point and the other being shown disconnected from a connection point.

### DETAILED DESCRIPTION OF THE PREFERRED EMBODIMENTS

Referring now to the drawings, like reference numerals designate identical or corresponding features throughout the several views.

Embodiments in accordance with the present invention may allow, for example, a seven-foot-tall tree to be perfectly lit in 10 minutes or less. Embodiments use low voltage LEDs, which are generally safer and significantly more energy efficient than conventional light bulbs. Unlike conventional lights, embodiments generally do not rely on removable bulbs. Therefore embodiments are more kid-safe and eliminate the “dead string of lights” syndrome commonly encountered in conventional string lighting systems.

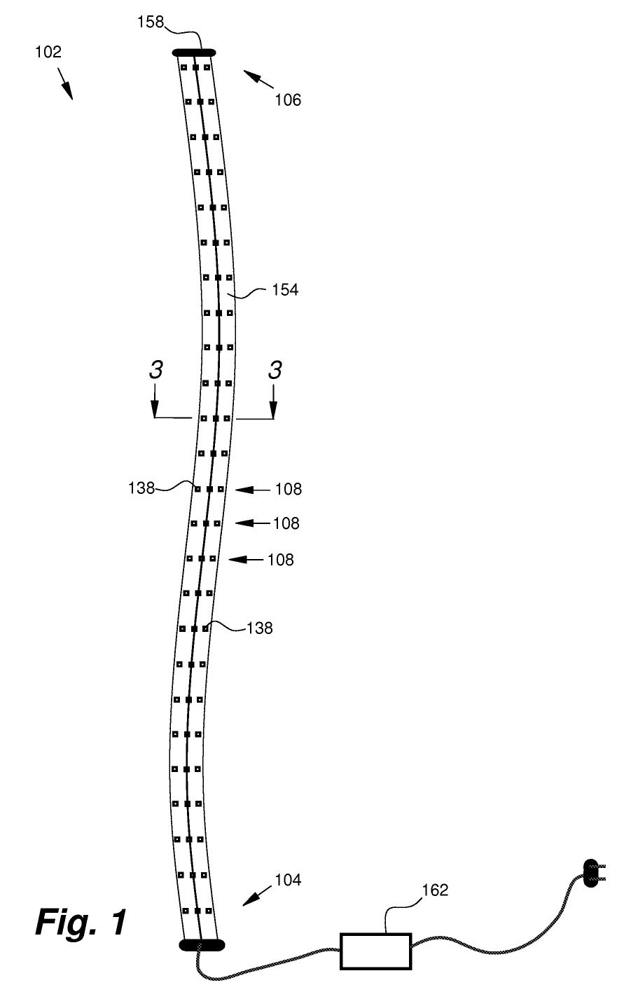

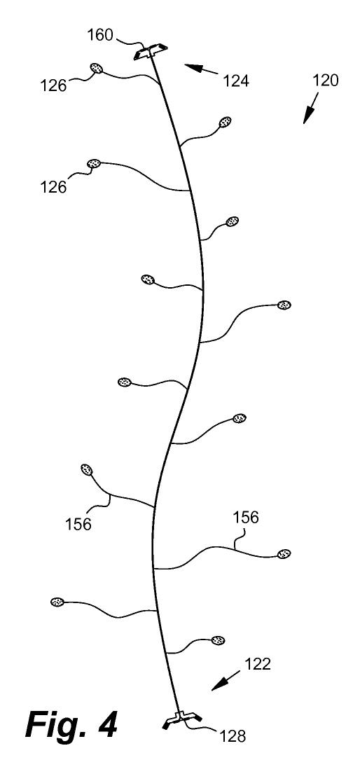

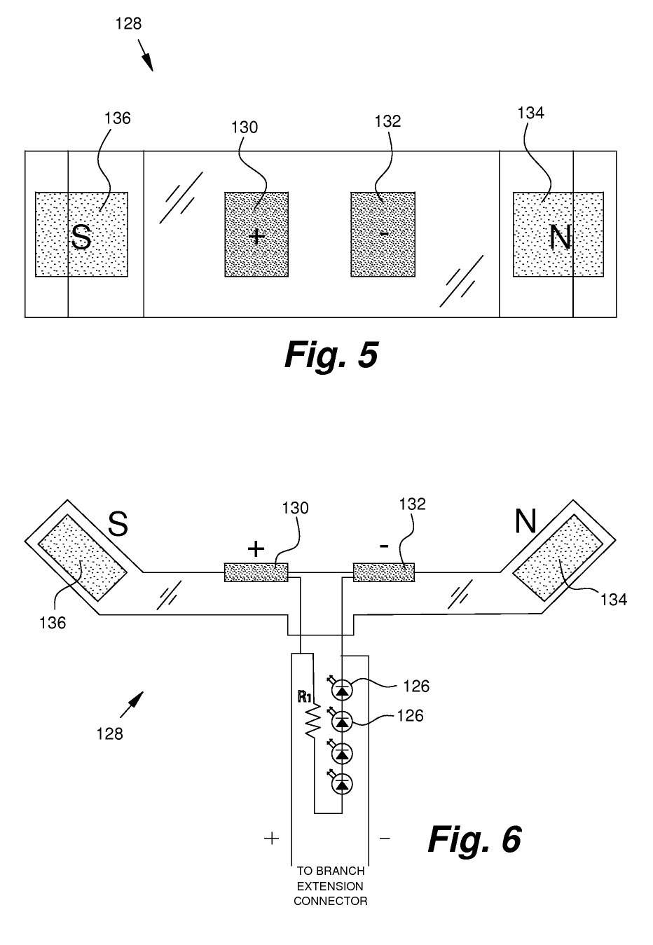

Referring to FIGS. 1 and 4 for illustration, generally speaking, embodiments of a kit described are powered through a central spine element 102 which may be arranged to weave conveniently up the center of, for example, a tree. Shorter branch elements 120 with low-voltage LEDs may be connected to the spine element 102 and may rest on a respective branch, thereby providing tree lighting which extends from the inside of the tree to the outside of the tree, rather than wrapping around the tree circumferentially. Illuminated connectors may be included in the spine element 102 to make connecting the branch elements 120 to specific locations on the spine element 102 a quick and easy. When lighting a tree, for example, the branch elements 120 can be connected to the spine element 102 from top to bottom, bottom to top, or starting anywhere in between. Varying branch element lengths, in combination with the overall modular configuration of embodiments of the system, allow a natural or artificial tree to appear to be appear perfectly lit up from the inside out.

Embodiments of a configurable modular LED lighting kit may comprise one or more spine elements 102 and one or more branch elements 120. Preferred embodiments may include or be adapted to be powered by a 24-volt DC LED power supply 162 which may be electrically connectable, for example, between a wall outlet and a connector on a spine element 102.

Referring to FIG. 1 for illustration, a spine element 102 may be elongated, may be plastically bendable and may include a first end 104, a second end 106, and a plurality of connection stations 108 disposed therebetween at distinctive distances from the first end 104. In certain embodiments, the connection stations 108 may be spaced apart at substantially equal distances, for example, every three inches. Each of the connection stations 108 may have a connection point 110 thereat. A connection point 110 may be defined by a combination of a spine positive electrical contact 112, a spine negative electrical contact 114, and a magnetic or mechanical spine connector element. In certain preferred embodiments, the connector element may be, for example, a spine north magnetic pole 116 and a spine south magnetic pole 118. In particular embodiments, such as the illustrated in FIG. 3, some connection points 110 may share a south pole and a north pole with other connection points 110 at, for example, the same respective connection station 108.

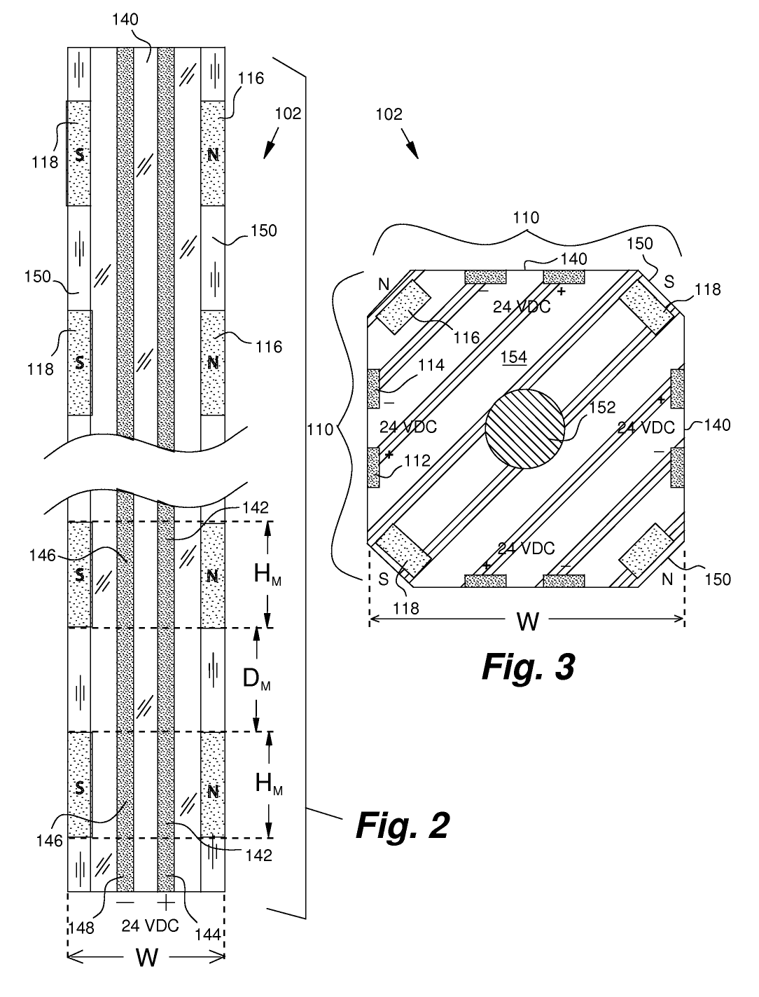

Referring to FIGS. 2 and 3 for illustration, in at least one embodiment, the spine element 102 may have a width W of, for example, approximately 0.75 inches. In at least one embodiment, each of the magnets on the spine element 102 may have a height H_{M} of, for example, approximately 0.5 inches. Similarly, in at least one embodiment, the magnets on the spine element 102 may be spaced from each other at a distance D_{M} of, for example, approximately 0.5 inches.

Referring to FIG. 4 for illustration, a branch element 120 may be being flexible and include a proximal end 122, a distal end 124 and a plurality of branch LEDs 126 disposed therebetween. Each of the proximal ends 122 may have a spine connector 128 generally thereat. Each of the spine connectors 128 may have a branch positive electrical contact 130, a branch negative electrical contact 132 and magnetic or mechanical branch connector element. A branch connector element may be configured to be releasably engageable with a respective spine connector element, and may include, for example, a branch north magnetic pole 134 and a branch south magnetic pole 136. In certain preferred embodiments, each of the spine connectors 128 may be configured to magnetically and electrically releasably connect with any of the connection points 110.

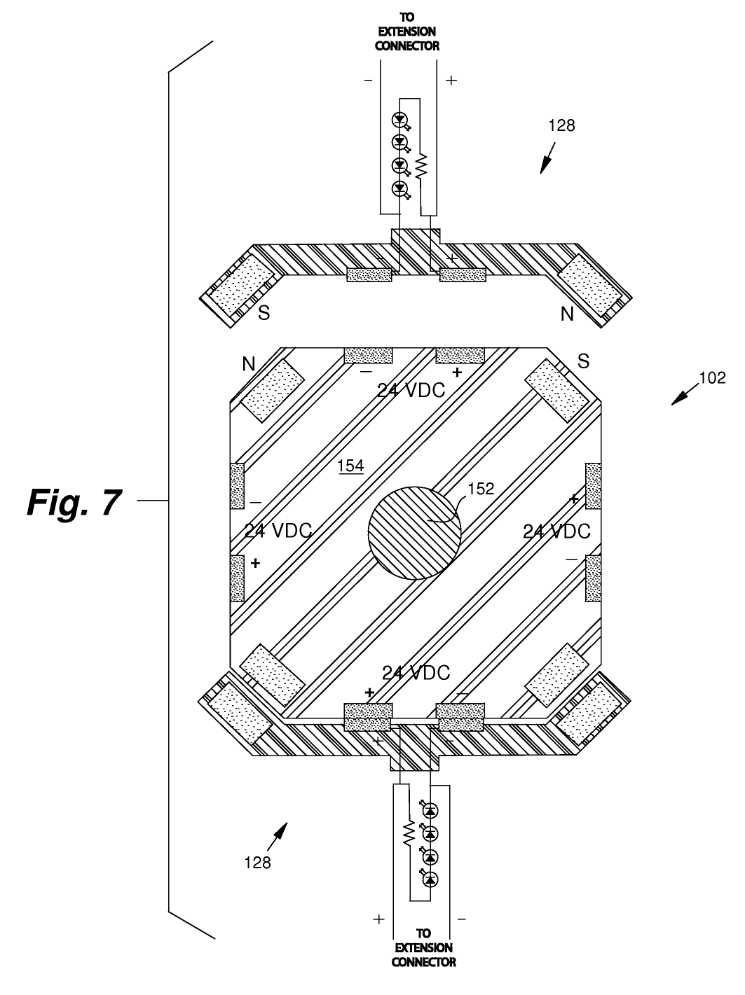

Referring to FIG. 6 for illustration, the magnetic poles discussed may be, for example, N42 Neodymium magnets, or the like. Each of the branch elements 120 may also include one or more resistors which provide a resistance R1 which is adapted according to the number of branch LEDs 126 on the respective branch element 120. Each R1 may be further adapted to ensure that the operating current remains between 20ma and 25ma. In particular embodiments, the branch positive electrical contacts 130 a branch negative electrical contacts 132 may be, for example, a thin copper or brass spring material to ensure a solid and reliable connection with respective contact strips on a spine element 102.

Referring to FIG. 1 for illustration, in particular embodiments of a modular LED lighting kit, each of the combinations may include a respective connection point LED 138 generally thereat. Referring to FIG. 3 for illustration, in certain embodiments, the spine element 102 may include a multiplicity of lateral faces 140. In particular such embodiments, for example, each of the connection stations 108 may include a plurality of connection points, and the connection points 110 of a connection station 108 may each correspond to a respective one of the lateral faces 140.

Referring to FIGS. 2 and 3 for illustration, in certain embodiments, the spine positive electrical contact 112 and the spine negative electrical contact 114 of each connection point 110 may be located at the same lateral face 140. In particular embodiments, the spine positive electrical contacts 112 on the same lateral face 140 are actually separate sections 142 of the same elongated positive contact strip 144. Similarly, the spine negative electrical contacts 114 on the same lateral face 140 may actually be separate sections 146 of an elongated negative contact strip 148. The contact strips may be, for example, a pliable electrical conductor. In certain embodiments, each of the spine positive electrical contacts 112 and spine negative electrical contacts 114 may be disposed generally between the respective spine north magnetic poles 116 and spine south magnetic poles 118.

Referring again to FIG. 3 for illustration, in particular embodiments, a spine element 102 may include corner faces 150 angularly disposed between each of the lateral faces 140. In such embodiments, for example, the spine north magnetic pole 116 and the spine south magnetic pole 118 of each of the connection points 110 may be disposed generally at a respective one of the corner faces 150. In embodiments, the magnets in the spine elements 102 may be, for example, embedded below the respective corner face 150.

Referring to FIG. 7 for illustration, in certain embodiments, each spine connector 128 may be configured to receivingly engage the spine element 102 at a connection point 110 such that its branch positive electrical contact 130 and branch negative electrical contact 132 are maintained in direct contact with the respective spine positive electrical contact 112 and spine negative electrical contact 114, and its branch north magnetic pole 134 and branch south magnetic pole 136 are in magnetic engagement with the respective spine south magnetic pole 118 and spine north magnetic pole 116, respectively.

Referring to FIG. 3 for illustration, in certain embodiments, the spine element 102 may be plastically bendable by way of, for example, a metallic core 152 within the spine element 102. This adaptation may help the spine element 102 hold its shape as it hugs and weaves up, for example, a tree trunk through or around tree branches. A spine element 102 may have a polymeric body 154 which is substantially light permeable. The polymeric body may be made substantially of, for example, a soft, light-permeable vinyl. Further or alternatively, the spine positive electrical contacts 112, spine negative electrical contacts 114, spine north magnetic poles 116, and spine south magnetic poles 118 may be generally embedded in or affixed to the polymeric body 154. In particular embodiments, the spine element 102 may even be stiff or rigid enough such that it is substantially resistant to self-buckling when placed in a generally vertical and generally extended orientation. Such rigidity may allow the spine element 102 to be snaked up, for example, the trunk of a Christmas tree, without collapsing under its own weight and falling to the floor, and without relying primarily on the branches of tree to support the weight of the spine element.

To make the emitted light more pleasing to the eye, in particular embodiments, each of the branch LEDs 126 may be substantially encapsulated by a diffusive layer (not shown). Further, the diffusive layer may be a textured plastic housing surrounding all or a portion of the LED.

Referring to FIG. 4 for illustration, in certain embodiments, each branch element 120 may have a branch length defined by the length of the branch element between the respective proximal end 122 and distal end 124. The branch elements 120 of certain preferred embodiment may have varying branch lengths. Further, the number of branch LEDs 126 may vary between branch elements 120 within an embodiment of the kit.

In particular embodiments, each of the branch LEDs 126 may be electrically connected to their respective branch element 120 by way of, for example, a branchlet 156. In such embodiments, for example, two or more of the branchlets 156 of each branch element 120 may have differing lengths and may be substantially flaccid.

In particular embodiments, the spine element 102 may include a spine extension connector 158 for electrically connecting to the first end 104 of an additional spine element 102. Similarly, in certain embodiments, one or more of the branch elements 120 may include a branch extension connector 160 at the respective distal end 124 for electrically connecting to a proximal end 122 of an additional branch element 120.

In operation, embodiments may be adapted for use in various indoor and outdoor lighting applications. However, certain embodiments may be particularly useful in providing a Christmas tree lighting system that mimics the way a natural tree grows. For example, the spine element 102 may be formed as a semi-flexible power bus that weaves its way up the trunk of the tree. The spine element 102 may be covered in clear vinyl like a rope light and may generally contain dozens of connection points 110. Each connection point 110 may be dimly lit with a contact point LED to make it easy to identify. On the end of the spine element may be a spine extension connector 158 to add additional lengths if needed. Once a branch element 120 is connected to the spine element 102, the branch LEDs 126 on the respective branch element 120 may immediately illuminate. Each branch element 120 may simply lie on top of a respective tree branch to light the tree perfectly from the inside out.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A configurable modular LED lighting kit, the lighting kit comprising:
a spine element being elongated, plastically bendable and including a first end, a second end, and a plurality of connection stations disposed therebetween at distinctive distances from the first end, each of the connection stations having a connection point thereat defined by a combination of a spine positive electrical contact, a spine negative electrical contact, a spine north magnetic pole, and a spine south magnetic pole; and
a multiplicity of branch elements, each of the branch elements being flexible and including a proximal end, a distal end and a plurality of branch LEDs disposed therebetween, each of the proximal ends having a spine connector generally thereat, each of the spine connectors having a branch positive electrical contact, a branch negative electrical contact, a branch north magnetic pole and a branch south magnetic pole, each of the spine connectors being configured to magnetically and electrically releasably connect with any of the connection points.

2. A lighting kit as defined in claim 1 in which each of the combinations include a respective connection point LED generally thereat.

3. A lighting kit as defined in claim 1 in which the spine element includes a multiplicity of lateral faces.

4. A lighting kit as defined in claim 3 in which each of the connection stations include a plurality of the connection points, the connection points of a connection station each corresponding to a respective one of the lateral faces.

5. A lighting kit as defined in claim 3 in which the spine positive electrical contact and the spine negative electrical contact of each connection point is located at one of the lateral faces.

6. A lighting kit as defined in claim 5 in which the spine positive electrical contacts on the same lateral face are separate sections of an elongated positive contact strip, and the spine negative electrical contacts on the same lateral face are separate sections of an elongated negative contact strip.

7. A lighting kit as defined in claim 3 in which the spine element includes corner faces angularly disposed between each of the lateral faces, and the spine north magnetic pole and the spine south magnetic pole of each of the connection points is disposed generally at a respective one of the corner faces.

8. A lighting kit as defined in claim 7 in which each of the spine connectors is configured to receivingly engage the spine element at a connection point such that its branch positive electrical contact and branch negative electrical contact are in direct contact with the respective spine positive electrical contact and spine negative electrical contact, and its branch north magnetic pole and branch south magnetic pole are in magnetic engagement with the respective spine south magnetic pole and spine north magnetic pole, respectively.

9. A lighting kit as defined in claim 7 in which the connection points share a south pole and a north pole with other connection points at the same respective connection station

10. A lighting kit as defined in claim 1 in which the spine element is plastically bendable by way of a metallic core within the spine element.

11. A lighting kit as defined in claim 1 in which the spine element has a polymeric body which is substantially light permeable, and the spine positive electrical contacts, spine negative electrical contacts, spine north magnetic poles, and spine south magnetic poles are generally embedded in or affixed to the polymeric body.

12. A lighting kit as defined in claim 1 in which each of the branch LEDs are substantially encapsulated by a diffusive layer.

13. A lighting kit as defined in claim 12 in which the diffusive layer is a textured plastic housing.

14. A lighting kit as defined in claim 1 in which the spine element is substantially resistant to self-buckling when placed in a generally vertical and generally extended orientation.

15. A lighting kit as defined in claim 1 further comprising a 24-volt DC LED power supply electrically connectable between a wall outlet and the spine element.

16. A lighting kit as defined in claim 1 in which each branch element has a branch length defined by the length of the branch element between the respective proximal end and distal end, the branch elements have varying branch lengths.

17. A lighting kit as defined in claim 1 in which each of the spine positive electrical contacts and spine negative electrical contacts are disposed generally between the respective spine north magnetic poles and spine south magnetic south poles.

18. A lighting kit as defined in claim 1 in which each of the branch LEDs are electrically connected to their respective branch element by way of a branchlet.

19. A lighting kit as defined in claim 18 in which two or more of the branchlets of each branch element have differing lengths and are substantially flaccid.

20. A lighting kit as defined in claim 1 in which the connection stations are spaced apart at substantially equal distances.

21. A lighting kit as defined in claim 1 in which the spine element includes a spine extension connector for electrically connecting to the first end of an additional spine element.

22. A lighting kit a defined in claim 1 in which one or more of the branch elements include a branch extension connector at the respective distal end for electrically connecting to a proximal end of an additional branch element.

23. A configurable modular LED lighting kit, the lighting kit comprising:
a spine element being plastically bendable and elongated with a multiplicity of lateral faces, and including a first end, a second end, and a plurality of connection stations disposed therebetween at distinctive distances from the first end, each of the connection stations having a multiplicity of connection points thereat defined by a combination of a spine positive electrical contact, a spine negative electrical contact and a connection point LED, the connection points of a connection station each corresponding to a respective one of the lateral faces, the spine element further including a polymeric body which is substantially light permeable, the spine positive electrical contacts and spine negative electrical contacts being generally embedded in or affixed to the polymeric body;
a multiplicity of branch elements, each of the branch elements being flexible and including a proximal end, a distal end and a plurality of branch LEDs disposed therebetween, each of the proximal ends having a spine connector generally thereat, each of the spine connectors having a branch positive electrical contact and a branch negative electrical contact, each of the spine connectors being configured to receivingly and electrically releasably connect with any of the connection points; and
a 24-volt DC LED power supply electrically connectable between a wall outlet and the spine element.
